(19) United States
(12) Patent Application Publication
(10) Pub. No.: US 2010/0168458 A1
(43) Pub. Date: Jul. 1, 2010

(54) PROCESS FOR CONVERTING SI-H COMPOUNDS TO SI-HALOGEN COMPOUNDS

(75) Inventors: Konrad Mautner, Jahnishausen (DE); Werner Geissler, Thiendorf (DE); Gudrun Tamme, Moritzburg (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/665,858

(22) PCT Filed: Jun. 11, 2008
(86) PCT No.: PCT/EP2008/057257

§ 371 Date: Jan. 14, 2010

(30) Foreign Application Priority Data
Jul. 4, 2007 (DE) 10 2007 030 948.3

(51) Int. Cl. C07F 7/12

(52) U.S. Cl. 556/477

(57) ABSTRACT

Silicon compounds having Si—H groups are converted into silicon compounds having Si—X groups by reaction with HX in the gas phase in the presence of a quaternary ammonium or phosphonium halide catalyst or an ionic chloride of a heterocycle organically substituted on the heteroatom.

The invention relates to a process for converting Si—H compounds into Si-halogen compounds in the gas phase by means of hydrogen halide.

In the preparation of halosilanes or organohalosilanes, mixtures which also contain Si—H-containing silanes are frequently obtained. The silanes can be desirable and can be isolated in pure form from the mixtures. However, they can also be undesirable and therefore have to be removed. The most common method of fractionating silane mixtures is distillation. If the boiling points of Si—H-containing silanes and one or more other silanes are quite close together or an azeotrope is formed, the distillation becomes complicated and costly.

U.S. Pat. No. 5,336,799 A describes the conversion of Si—H-containing compounds into the corresponding organosilanes by reaction with organic halides over Pt or Pd catalysts. The reaction rates are slow and comparatively expensive organic halides are required.

EP 423948 A describes the reaction of Si—H-containing organosilanes with hydrogen halide over metal catalysts such as Pd, Pt, Ni to form organohalosilanes. The catalysts are expensive and deactivation of the catalysts by slow oxidation to metal halides takes place.

U.S. Pat. No. 5,302,736 A describes Ag or Au catalysts for this purpose, but the reaction proceeds too slowly.

U.S. Pat. No. 3,754,077 A describes the conversion of halosilanes having one or more Si—H bonds into tetrahalosilane in the gas phase by means of hydrogen halide over solid catalysts such as activated carbon, Al₂O₃ or SiO₂. The process has been developed only for silanes without an organic radical and requires temperatures at or above 200° C.

It is an object of the invention to provide an improved process for converting the Si—H-containing silanes into silanes having altered boiling points.

The invention provides a process for converting silicon compounds (H) which have Si—H bonds into silicon compounds (Cl) which have Si-halogen bonds, wherein the silicon compounds (H) are reacted in the gas phase with hydrogen halide in the presence of catalysts selected from among

(a) tetraorganophosphonium halides,

(b) tetraorganoammonium halides and

(c) ionic halides of heterocycles which are organically substituted on the heteroatom.

The process proceeds at relatively low temperatures and is suitable for all vaporizable silicon compounds (H) which have Si—H bonds. The catalyst has very long operating lives and is very easy to handle.

Preferred silicon compounds (H) which have Si—H bonds are organopolysiloxanes, organopolysilanes and in particular monosilanes.

The silanes (H) preferably have the general formula 1

RₓSiH₄₋ₓ (1),

where

R is a monovalent, C₁-C₁₈-hydrocarbon radical which may be substituted by halogen radicals or is a halogen radical and

x is 1, 2 or 3.

The C₁-C₁₈-hydrocarbon radicals R are preferably phenyl radicals or C₁-C₆-alkyl radicals, a vinyl or allyl radical, in particular methyl or ethyl radicals. Halogen substituents on R are preferably fluorine, chlorine and bromine, in particular chlorine.

Halogen radicals R are preferably fluorine, chlorine and bromine, in particular chlorine.

The process of the invention is suitable for use in the purification of crude products and prepurified products from the direct synthesis of methylchlorosilanes, in particular of methylchlorosilanes which contain, as by-products, silicon compounds (H), in particular EtHSiCl₂, and possibly further by-products. The preferred concentration of silicon compounds (H) in the methylchlorosilanes is from 10 to 5000 ppm.

The hydrogen halide used is preferably hydrogen chloride or hydrogen bromide, in particular hydrogen chloride.

Preference is given to using from 1.5 to 50 mol, in particular from 3 to 10 mol, of hydrogen halide per mole of hydrogen of the silicon compounds (H).

As catalysts (a) and (b), preference is given to using:

(a) tetraorganophosphonium halides of the general formula 2

R¹₄PX¹ (2)

and

(b) tetraorganoammonium halides of the general formula 3

R²_{4N}X², (3)

where

R¹ and R² are each an optionally halogen-substituted, optionally heteroatom-containing C₁-C₁₈-hydrocarbon radical and

X¹ and X² are each a halogen atom.

R¹ and R² can be, for example, branched, unbranched or cyclic alkyl radicals and multiple bond systems such as aryl, alkaryl and aralkyl radicals. The radicals R¹ and R² preferably have from 1 to 10 carbon atoms; in particular, the radical R¹ and R² is an alkyl radical having from 2 to 8 carbon atoms.

The halogen atom X¹ or X² is preferably chlorine, bromine or iodine, in particular chlorine.

Preference is given to (n-butyl)₄PCl and (n-butyl)₃(n-octyl)PCl. The preparation of such homogeneous catalysts by alkylation of tertiary phosphines by means of alkyl halides is described, for example, in Houben-Weyl, Georg Thieme Verlag, volume XII/1, pp. 79-90, 1963.

As catalysts (c), preference is given to using: halide salts of positively charged heterocycles in which nitrogen or phosphorus atoms are organically substituted.

Preferred positively charged heterocycles are imidazolium salts and pyridinium salts, in particular imidazolium salts of the general formula 4

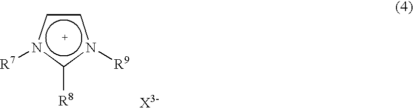

and

pyridinium salts of the general formula 5

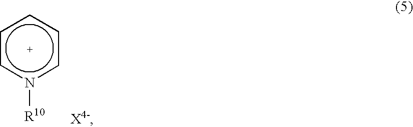

where

R⁸ is hydrogen or has the meanings of R¹ and R², R⁷, R⁹ and R¹⁰ have the meanings of re and R² and X³ and X⁴ have the meanings of X¹ and X².

The halogen of the hydrogen halide used preferably corresponds to the halogen of X¹, X², X³ and X⁴. In particular, X¹, X², X³ and X⁴ are each hydrogen chloride.

In a preferred embodiment, the catalysts (c) are ionic liquids, namely low-melting salts. Their preferred melting points for the present process are not more than 150° C., preferably not more than 100° C. at 1 bar. The radicals of the cations of the ionic liquids preferably correspond to the above-described radicals R¹ and R².

It is possible to use pure catalysts (a), (b) or (c) or a mixture of catalysts selected from among the catalysts (a), (b) and (c).

The hydrogen halide used is preferably hydrogen chloride or hydrogen bromide, in particular hydrogen chloride.

The catalysts (a), (b) and (c) are preferably used in undiluted form or as a solution in a preferably high-boiling inert organic solvent, preferably a hydrocarbon such as tetralin or decalin. The catalysts (a), (b) and (c) can also be used on solid supports.

Pressure and temperature can be varied within wide ranges and are preferably matched to the conditions of an upstream column which provides a fraction enriched in silicon compounds (H), in particular EtHSiCl₂.

The process of the invention is preferably carried out at temperatures at which the silicon compounds (Cl) are liquid. The process of the invention is in particular carried out at at least 30° C., in particular at least 70° C., and preferably at temperatures of not more than 160° C., in particular not more than 120° C.

The process of the invention is preferably carried out in a tube reactor, with the mixture preferably being fed in in vapor form.

All symbols in the above formulae have their meanings independently of one another in each case.

In the following example, all amounts and percentages are, unless indicated otherwise, by weight, all pressures are 0.10 MPa (abs.) and all temperatures are 20° C.

### Example

A tube reactor which has an internal diameter of 20 mm and a length of 600 mm and is heated by means of a heat-transfer medium is charged with 80 g of tetra-butylphosphonium chloride. 230 g/h of a gaseous methylchlorosilane fraction containing 360 ppm of ethyldichlorosilane and 1300 ppm C₇-C₈ hydrocarbons are passed together with 1 l/h of hydrogen chloride through the catalyst at a temperature of the heat-transfer medium of 90° C. and a gauge pressure of 10 mbar. The height of the bubble column is established at about 500 mm. The product condensed with slight reflux in a 30 cm long packed column is analyzed by means of GC. It contains 20 ppm of ethyldichlorisilane; the C₇-C₈ hydrocarbons are not dissociated.

1.-5. (canceled)

6. A process for converting silicon compounds which have Si—H bonds into silicon compounds which have Si-halogen bonds, comprising reacting the silicon compounds having Si—H bonds in the gas phase with hydrogen halide in the presence of at least one catalyst selected from the group consisting of
(a) tetraorganophosphonium halides,
(b) tetraorganoammonium halides, and
(c) ionic halides of heterocycles which are organically substituted on the heteroatom.

7. The process of claim 6, wherein the silicon compounds are silanes of the formula 1
RₓSiH₄₋ₓ (1),
where
R is a monovalent, C₁-C₁₈-hydrocarbon radical optionally substituted by halogen radicals or is a halogen radical and
x is 1, 2 or 3.

8. The process of claim 6, wherein the hydrogen halide is hydrogen chloride.

9. The process of claim 7, wherein the hydrogen halide is hydrogen chloride.

10. The process of claim 6, wherein at least one of:
(a) tetraorganophosphonium halides of the formula 2
R¹₄PX¹ (2)
and
(b) tetraorganoammonium halides of the formula 3
R²₄X², (3)
where
R¹ and R² are each an optionally halogen-substituted, optionally heteroatom-containing C₁-C₁₈-hydrocarbon radical and
X¹ and X² are each a halogen atom,
are used as catalysts (a) and (b), respectively.

11. The process of claim 6, wherein at least one of:
imidazolium salts of the formula 4 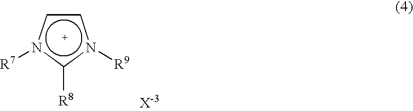
or
pyridinium salts of the general formula 5 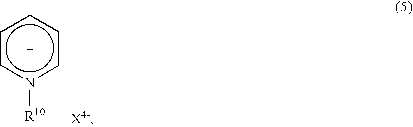
where
R⁸ is hydrogen or are each an optionally halogen-substituted, optionally heteroatom-containing C₁-C₁₈-hydrocarbon radical and
R⁷, R⁹ and R¹⁰ have the meanings of R¹ and R², and
X³ and X⁴ are each a halogen atom,
are used as catalysts (c).
